(19) United States
(12) Patent Application Publication
(10) Pub. No.: US 2026/0246644 A1
(43) Pub. Date: Aug. 20, 2026

(54) ELECTRONIC DEVICE COMPRISING SECURITY MANAGEMENT SYSTEM

(71) Applicant: Renesas Electronics Corporation, Tokyo (JP)

(72) Inventors: Arunshankar Muruga Dhandayuthapany, West Bloomfield, MI (US); Shashank Bangalore Lakshman, Folsom, CA (US); Ranjeeth Kumar Sukumar, Canton, MI (US)

(73) Assignee: Renesas Electronics Corporation, Tokyo (JP)

(21) Appl. No.: 19/058,470

(22) Filed: Feb. 20, 2025

(51) Int. Cl. H04L 9/32

(52) U.S. Cl. CPC H04L 9/3228

(57) ABSTRACT

An electronic device and a secure electronic apparatus are provided. The electronic device includes a security management system configured to control access to each of a plurality of system components based on a reconfigurable secure enclave definition. A method of controlling access to each of the plurality of system components, based on a reconfigurable secure enclave definition using a security management system of an electronic device, is also provided.

### TECHNICAL FIELD

The present disclosure relates to an electronic device comprising a security management system.

### BACKGROUND

Trained AI models are proprietary core intellectual property (IP) required for the successful functioning of Advanced Driver Assistance Systems and Automated Driving systems (ADAS/AD). Such models may be vulnerable to reverse-engineering by competitors or hacking by bad actors.

Electronic devices using artificial intelligence (AI) models, such as automotive system-on-chips (SoC), may use AI model security solutions to restrict access to the AI model IP during development, production and on-road lifecycle phases.

### SUMMARY

It is desirable to provide improved security in electronic devices. In particular it is desirable to provide improved AI model security in electronic devices such a SoCs.

According to a first aspect of the disclosure there is provided an electronic device comprising a security management system configured to control access to each of a plurality of system components based on a reconfigurable secure enclave definition.

Optionally, the electronic device comprises a plurality of artificial intelligence (AI) hardware acceleration intellectual property (IP) blocks.

Optionally, the security management system is configured to control access to i) each of the plurality of AI hardware acceleration IP blocks based on the reconfigurable secure enclave definition, and/or ii) each of a plurality of memory storage blocks based on the reconfigurable secure enclave definition.

Optionally, the electronic device comprises a memory interface configured to permit communication between the electronic device and a memory sub-system comprising the plurality of memory storage blocks.

Optionally, one or more of the plurality of memory storage blocks is configured to store a compiled artificial intelligence (AI) model comprising the reconfigurable secure enclave definition.

Optionally, the compiled AI model is received by the one or more of the plurality of memory storage blocks from a compiler configured to receive a first pre-trained AI model, receive a first security management configuration file that describes a first setting for the reconfigurable secure enclave definition, and generate the compiled AI model comprising the first pre-trained AI model and the reconfigurable secure enclave definition based on the first setting.

Optionally, the electronic device comprises a security processor core comprising the security management system and configured to decrypt the compiled AI model using a one-time password.

Optionally, the electronic device comprises an application processor unit (APU).

Optionally, the security management system is configured to restrict the APU's access to one or more of the plurality of system components based on the reconfigurable secure enclave definition.

Optionally, the security processor core is configured to perform an initialization sequence based on security firmware, the initialization sequence being used to enforce the reconfigurable secure enclave definition prior to activation of the APU.

Optionally, the one or more of the plurality of memory storage blocks is configured to store an updated compiled artificial intelligence (AI) model comprising the reconfigurable secure enclave definition, and the updated compiled AI model is received by the one or more of the plurality of memory storage blocks from the compiler configured to receive a second pre-trained AI model, receive a second security management configuration file that describes a second setting for the reconfigurable secure enclave definition, and generate an updated compiled AI model comprising the second pre-trained AI model and the reconfigurable secure enclave definition based on the second setting.

Optionally, the security processor core is configured to perform an initialization sequence based on security firmware, the initialization sequence being used to enforce the reconfigurable secure enclave definition based on the first setting, after the one or more of the plurality of memory storage blocks receives the compiled AI model, and perform a re-initialization sequence based on security firmware, the re-initialization sequence being used to enforce the reconfigurable secure enclave definition based on the second setting, after the one or more of the plurality of memory storage blocks receives the updated compiled AI model.

Optionally, the electronic device is configured to undergo a power reset procedure after the one or more of the plurality of memory storage blocks receives the updated compiled AI model and before the security processor core performs the re-initialization sequence.

Optionally, the secure processor core is configured to validate the changes to the reconfigurable secure enclave definition after re-initialization.

Optionally, the electronic device is a system-on-chip (SoC), a microcontroller unit (MCU), chiplets or a system-on-module.

According to a second aspect of the disclosure there is provided a secure electronic apparatus comprising a plurality of memory storage blocks, an electronic device comprising i) a plurality of artificial intelligence (AI) hardware acceleration intellectual property (IP) blocks, and ii) a security management system configured to control access to a) each of the plurality of AI hardware acceleration IP blocks based on a reconfigurable secure enclave definition, and/or b) each of the plurality of memory storage blocks based on the reconfigurable secure enclave definition, and a compiler configured to i) receive a first pre-trained AI model, ii) receive a first security management configuration file that describes a first setting for the reconfigurable secure enclave definition, and iii) generate the compiled AI model comprising the first pre-trained AI model and the reconfigurable secure enclave definition based on the first setting, wherein one or more of the plurality of memory storage blocks is configured to receive the compiled AI model from the compiler, and store the compiled artificial intelligence (AI) model comprising the reconfigurable secure enclave definition.

It will be appreciated that the secure electronic apparatus of the second aspect may include features set out in relation to the first aspect and may include other features as described herein in accordance with the understanding of the skilled person.

According to a third aspect of the disclosure there is provided a method of controlling access to each of a plurality of system components based on a reconfigurable secure enclave definition using a security management system of an electronic device.

Optionally, the electronic device comprises a plurality of artificial intelligence (AI) hardware acceleration intellectual property (IP) blocks, the method comprising controlling access, using the security management system, to i) each of the plurality of AI hardware acceleration IP blocks based on the reconfigurable secure enclave definition, and/or ii) each of a plurality of memory storage blocks based on the reconfigurable secure enclave definition.

Optionally, the method comprises storing a compiled artificial intelligence (AI) model comprising the reconfigurable secure enclave definition using one or more of the plurality of memory storage blocks.

Optionally, the method comprises receiving a first pre-trained AI model at a compiler, receiving a first security management configuration file that describes a first setting for the reconfigurable secure enclave definition at the compiler, generating, using the compiler, the compiled AI model comprising the first pre-trained AI model and the reconfigurable secure enclave definition based on the first setting, and receiving, using the one or more of the plurality of memory storage blocks, the compiled AI model from the compiler.

Optionally, the method comprises storing an updated compiled artificial intelligence (AI) model comprising the reconfigurable secure enclave definition using the one or more of the plurality of memory storage blocks, receiving a second pre-trained AI model at a compiler, receiving a second security management configuration file that describes a second setting for the reconfigurable secure enclave definition at the compiler, generating, using the compiler, the updated compiled AI model comprising the second pre-trained AI model and the reconfigurable secure enclave definition based on the second setting, and receiving, using the one or more of the plurality of memory storage blocks, the updated compiled AI model from the compiler.

It will be appreciated that the method of the third aspect may include providing and/or using features set out in relation to the first and/or second aspects and may include other features described herein, in accordance with the understanding of the skilled person.

### BRIEF DESCRIPTION OF THE DRAWINGS

The disclosure is described in further detail below by way of example and with reference to the accompanying drawings in which:

FIG. 1A is a schematic of an electronic device comprising a security management system in accordance with a first embodiment of the present disclosure, FIG. 1B is a schematic of secure electronic apparatus comprising the electronic device in accordance with a second embodiment of the present disclosure;

FIG. 2 is a schematic of a specific embodiment of the secure electronic apparatus comprising the electronic device in accordance with a third embodiment of the present disclosure;

FIG. 3A is an illustration of an example security management configuration file, FIG. 3B is a table showing access rights to different components for an example scenario with an OEM being the AI model owner; and

FIG. 4 is a schematic of a portion of the secure electronic apparatus of FIG. 2.

### DETAILED DESCRIPTION

There are two known methods that can offer varying degrees of AI model security:
1) Authentication based model protection that authenticates access to the model at runtime. However, it also brings overheads in runtime which results in long system latency. This approach limits performance and entitlement of silicon IP.
2) Secure domain-based approach that uses a statically defined security enclave that does not offer flexibility to reconfigure AI acceleration IP resources for different scenarios or applications.

A limitation of the above approaches is that they are mainly for model security when the product is deployed and they do not allow for dynamic security definitions which may be beneficial across the development life cycle.

For example, ADAS product development involves multiple stakeholders (OEMS, Tier 1's, Third Party Stack providers) some of whom do not need to access the AI model as they work on developing the product.

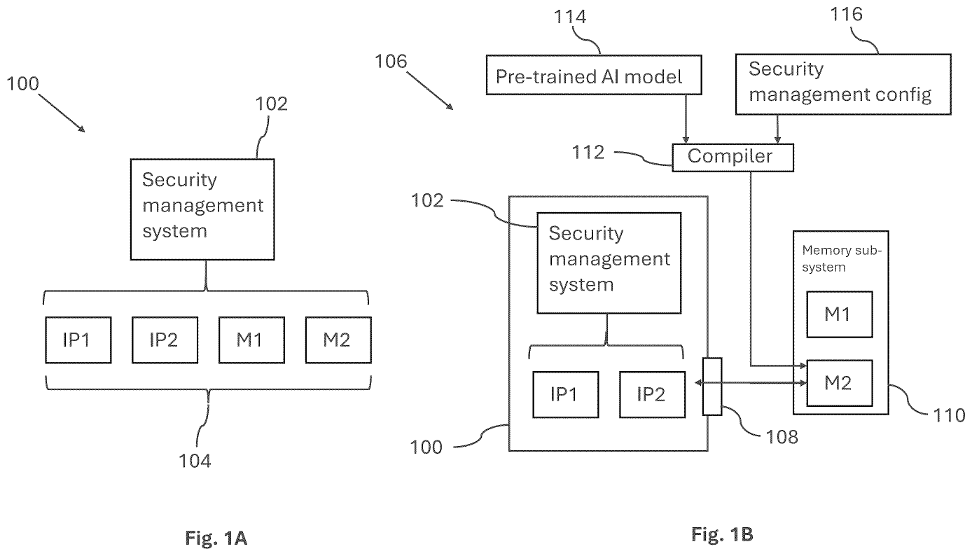

FIG. 1A is a schematic of an electronic device 100 comprising a security management system 102 in accordance with a first embodiment of the present disclosure.

The security management system 102 is configured to control access to each of a plurality of system components 104 based on a reconfigurable secure enclave definition.

The reconfigurable secure enclave definition includes information on which system components 104 are accessible, for example by a user or by another component, and which system components 104 are not accessible. Using the reconfigurable secure enclave definition, the security management system 102 can restrict access to system components 104 that include sensitive information, for example relating to a trained AI model.

In contrast with known systems, embodiments of the present disclosure use a secure enclave definition that is reconfigurable, rather than static. This means that the security enclave definition may be updated to change the access controls provided by the security management system 102 across the development life cycle of the electronic device 100.

It will be appreciated that there are multiple methods to restrict access to system components. For example, encryption may be applied to data held within components to make the data “unreadable” to a user without access to the correct decryption process. Access restriction may also permit certain actions but prevent others. For example, a user may be permitted to read data held within a component, but prevented from editing the data without authorization. In a further example, access restriction may result in a user being restricted from controlling a component to provide a specific operation.

The security management system 102 may be implemented in the hardware of the electronic device 100. The security management system 102 may provide security control for multiple users across multiple system components 104.

The electronic device 100 may be an SoC, such as an automotive SoC. In the present disclosure, embodiments are described primarily for cases where the electronic device 100 is an SoC. However, it will be appreciated that in further embodiments, the electronic device 100 may alternatively be a microcontroller unit (MCU), chiplets or a system-on-module.

The electronic device 100 may comprise a plurality of artificial intelligence (AI) hardware acceleration IP blocks IP1, IP2. The AI hardware acceleration IP blocks IP1, IP2 may be heterogeneous.

IP blocks are building blocks of electronic systems such as SoCs that have been designed to provide a specific functionality for the overall electronic system. For example, IP blocks may include integrated circuit layout designs. IP blocks are well known in the technical field, and may be referred to as IP cores, or “IP”.

In the present example, and when implemented in a physical circuit, the IP blocks IP1, IP2 are circuits that provide specific functionalities as part of the overall electronic device 100.

An AI hardware accelerator is used to accelerate application relating to AI technology, including machine learning. Hardware acceleration describes the use of computer hardware to perform functions more efficiently that an equivalent system being performed in software.

AI hardware accelerator IP blocks are IP blocks that use AI hardware acceleration. In embodiments of the present disclosure AI hardware acceleration IP blocks may comprise one or more of: a neural processing unit (NPU), a convolutional neural network IP (CNNIP), a digital signal processor (DSP), or a graphical processing unit (GPU).

The security management system 102 may be configured to control access to each of the AI hardware acceleration IP blocks IP1, IP2 based on the reconfigurable secure enclave definition. Additionally, or alternatively, the security management system 102 may be configured to control access to each of a plurality of memory storage blocks M1, M2 based on the reconfigurable secure enclave definition.

In the present example, the system components 104 that the security management system 102 controls access to during operation, includes the plurality of AI hardware acceleration IP blocks IP1, IP2 and the plurality of memory storage blocks M1, M2.

In specific embodiments, controlled access may be granular. For example the security management system 102 may be configured to permit access to a first portion of the AI hardware acceleration IP block IP1 and restrict access to a second portion of the AI hardware acceleration IP block IP1.

FIG. 1B is a schematic of secure electronic apparatus 106 comprising the electronic device 100 in accordance with a second embodiment of the present disclosure. In the present example, the electronic device 100 comprises a memory interface 108 that is configured to permit communication between the electronic device 100 and a memory sub-system 110. The memory sub-system 110 may comprise the memory storage blocks M1, M2.

During operation a compiled artificial intelligence (AI) model comprising the reconfigurable secure enclave definition may be stored in at least one of the memory blocks M1, M2. In the present example, the compiled AI model is illustrated as being stored in the memory block M2.

An AI model is a software program using AI methods to perform a function. The AI model may have been trained using a conventional AI training process. For example, the AI model may have been provided with training data, and then through an iterative process, updated to provide the desired functionality. The training process may have resulted in the generation of AI model artefacts, such as model weightings or model parameters. The artefacts may be components of the trained AI model and therefore may represent valuable proprietary information that it is desirable to maintain secure within the electronic device 100. The artefacts may be stored as part of the compiled AI model.

The compiled AI model may be in a binary format for storage in one or more of the memory blocks M1, M2. The compiled AI model may be encrypted and require decryption before it can be used by the electronic device 100. The electronic device 100 may run the compiled AI model using a combination of the AI hardware acceleration IP blocks IP1, IP2, and the memory blocks M1, M2.

To generate the compiled AI model, a compiler 112 may receive a pre-trained AI model 114. The pre-trained AI model may be provided as source code that is in a high-level language. The pre-trained AI model is the AI model after it has undergone a training process and may include artefacts as a result of the training procedure.

The compiler 112 may also receive a security management configuration file 116 that describes a setting for the reconfigurable secure enclave definition. For example, this may include details of which components are to be accessible to a given user, and which components are to be restricted 104. In the present example, the security management configuration file 116 may indicate that access is to be restricted to the IP block IP2 and the memory block M2.

A compiler is a well-known system in the technical field and may be used to converter source code to machine code, which may be a binary representation of the pre-trained AI model and reconfigurable secure enclave definition.

During the product life cycle, the AI model may change, for example through further training. Additionally, it may be desirable to alter the security status of components 104. For example, it may be desirable to permit access to one component that was previously restricted and/or restrict access to another component that was previously accessible.

During operation an updated compiled artificial intelligence (AI) model comprising the reconfigurable secure enclave definition may be stored in at least one of the secure memory blocks M1, M2. As the secure enclave definition is reconfigurable it may be updated to reflect the new security requirements.

To generate the updated compiled AI model, the compiler 112 may receive an updated pre-trained AI model and an updated security management configuration file that describes an updated setting for the reconfigurable secure enclave definition.

The use of a secure enclave definition that is reconfigurable means that the security access can be altered thereby enabling AI model protection throughout the product lifecycle from development to production and, for automotive application, to on-road.

Embodiments of the present disclosure may ensure that the model owner can redefine the security enclave depending upon AI application requirements, without requiring application re-design or introducing overheads.

Embodiments of the present disclosure can provide a low-overhead security management system, provided by the security management system 102, that arbitrates secure high-performance inference across heterogeneous AI acceleration hardware IP in an SoC.

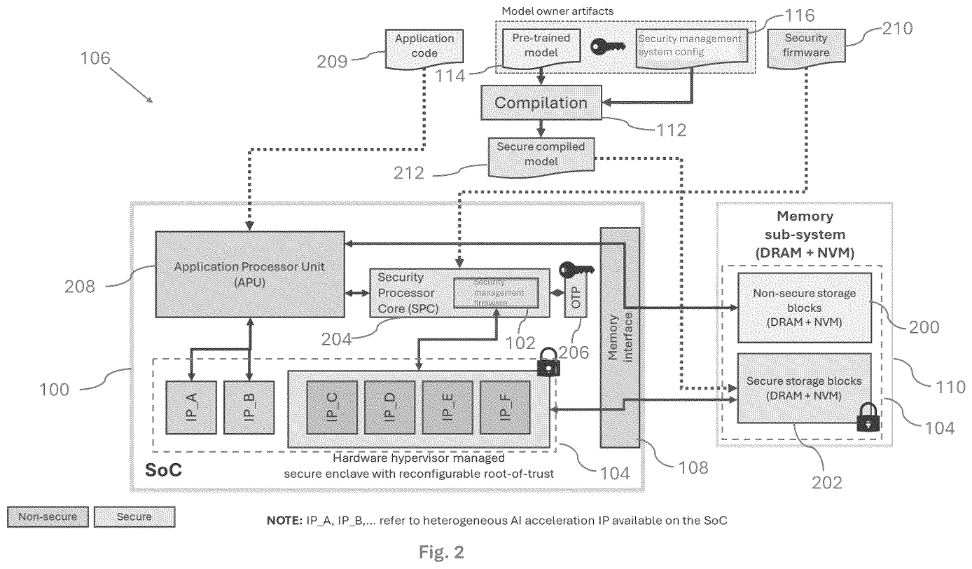

FIG. 2 is a schematic of a specific embodiment of the secure electronic apparatus 106 comprising the electronic device 100 in accordance with a third embodiment of the present disclosure. In the present example, the electronic device 100 is a SoC.

In the present example the plurality of system components 104 comprises AI hardware acceleration IP blocks IP_A, IP_B, IP_C, IP_D, IP_E, IP_F, a first set of memory storage blocks 200 and a second set of memory storage blocks 202. Each of the sets of memory storage blocks 200, 202 comprises a plurality of memory storage blocks.

In the present example, the security management system 102 is configured to control access to the AI hardware acceleration IP blocks IP_A-IP_F and the memory storage blocks of the sets of the memory storage blocks 200, 202 based on the reconfigurable secure enclave definition. In the present example, the security management system 102 has set IP block IP_A, IP_B as being accessible and IP blocks IP_C, IP_D, IP_E, IP_F as being secure and inaccessible. Additionally, the security management system 102 has set the first set of memory storage blocks 200 as being non-secure and the second set of memory storage blocks 202 as being secure.

The electronic device 100 may comprise a security processor core 204 comprising the security management system 102 and being configured to decrypt the compiled AI model using a one-time password (OTP) that may be stored in one of a plurality of OTP storage registers 206. The decryption may ensure that model weights are available to the secure IP blocks IP_C-IP_F and the secure memory 202.

The OTP may be flashed as part of an initial set up and then may remain unchanged through the lifetime of the device. There may be provided multiple OTP storage registers for one-time passwords for different users.

The electronic device 100 may comprise an application processor unit (APU) 208. The APU 208 may be a general purpose processor and may receive instructions for its operation in the form of application code 209. The security management system 102 may be configured to restrict the APU's 208 access to one or more of the plurality of system components 104 based on the reconfigurable secure enclave definition. In the present embodiment the IP blocks IP_A, IP_B are accessible to the APU 208 whereas the IP blocks IP_C-IP_F are secure and inaccessible. Additionally, the set of memory storage blocks 200 is non-secure and therefore accessible to the APU 208, and the set of memory storage blocks 202 is secure and therefore inaccessible to the APU 208.

During operation, the security processor core 204 may perform an initialization sequence based on security firmware 210. The initialization sequence may be used to enforce the reconfigurable secure enclave definition prior to activation of the APU 208. This ensures that the necessary components are secured prior to any potential access attempts from the APU 208.

In FIG. 2 the compiled AI model provided by the compiler 112 is labelled using reference numeral 212. As the compiled AI model 212 is encrypted it is referred to as a secure compiled model in the schematic.

In the present example the following components are secure: the compiler 112, the security management configuration file 116, the second set of memory storage blocks 202, the security processor core 204 (including the security management system 102), the OTP storage register 206, the security firmware 210, the compiled AI model 212, and the AI hardware acceleration IP blocks IP_C, IP_D, IP_E, IP_F.

In the present example the following components are non-secure: the memory interface 108, the pre-trained AI model 114, the first set of memory storage blocks 200, the APU 208, the application code 209 and the AI hardware acceleration IP blocks IP_A, IP_B.

The security processor core 204 may perform a subsequent initialization sequence, which may be referred to as a re-initialization sequence, when an updated compiled AI model including an updated reconfigurable secure enclave definition is provided to the set of memory storage blocks 202. During operation, the electronic device 100 may undergo a power reset procedure after the set of memory storage blocks 202 receives the updated compiled AI model and prior to the re-initialization sequence. The security processor core 204 may be configured to validate the changes to the reconfigurable secure enclave definition after re-initialization.

An example operation of a practical implementation of the secure electronic apparatus 106 of FIG. 2 may be summarised as follows.

Initially a sequence of steps may be undertaken to secure access the AI model artefacts by the specific AI hardware acceleration IP blocks within the SoC as follows:
1. A model owner creates the security management configuration file 116 that describes the AI hardware acceleration IP blocks to be included in the secure enclave.
2. The security management configuration file 116 is used by the compiler 112 to custom compile for secure IP targets only, which comprises the heterogenous AI hardware acceleration IP blocks to be secured. Now the binary code of the compiled AI model includes the definitions of the secure enclave which flags the full AI model, or parts of the AI model, as secure components.
3. The model owner flashes the OTP in the OTP storage register 206. “Flashing” refers to the process of transferrin the OTP data to memory within the SoC. This procedure may be carried out once per device lifetime.
4. The model owner flashes the security core firmware 210 and the compiled AI model 212.

The above steps complete the definition and setup of secure access to the model artifacts by specific hardware acceleration IP within the SoC.

A bank of OTP registers may be available for a multiple model owner scenario, so that each model owner has their own unique OTP and do not have access to other models.

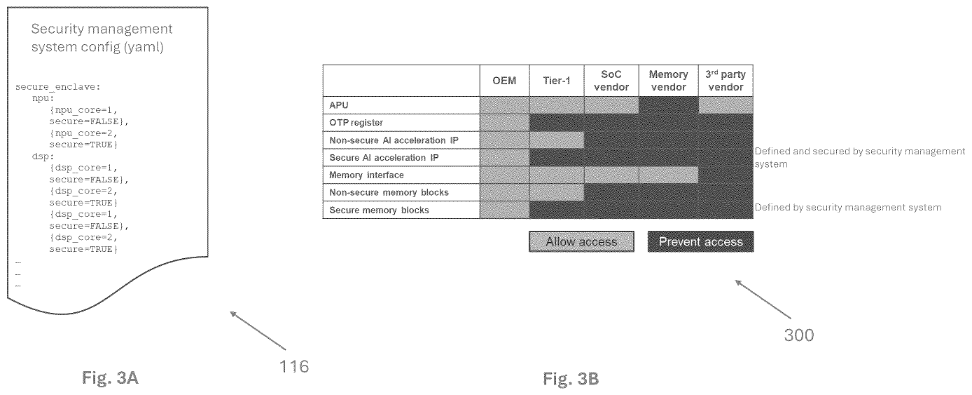

FIG. 3A is an illustration of an example security management configuration file 116. For example npu_core=1 may denote an AI acceleration hardware IP block that is a first NPU core, with “secure=FALSE” denoting that the first NPU core is not secured. For example npu_core=2 may denote an AI acceleration hardware IP block that is a second NPU core, with “secure=TRUE” denoting that the second NPU core is secured.

FIG. 3B is a table 300 showing access rights to different components for an example scenario with an OEM being the AI model owner. The access rights shown in the table 300 may be provided by the appropriate settings in the reconfigurable secure enclave definition and enforced by the security management system 102 during operation of the electronic device 100.

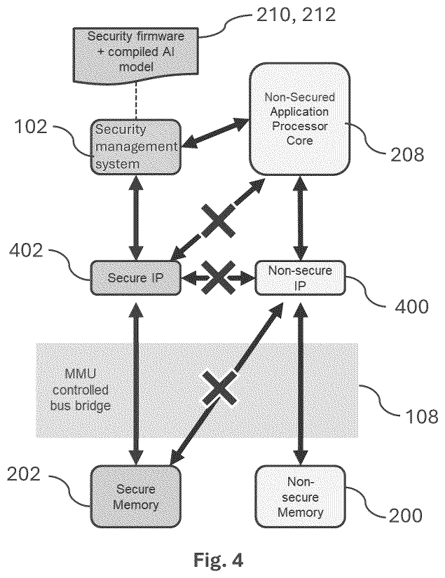

FIG. 4 is a schematic of a portion of the secure electronic apparatus 106 of FIG. 2. In FIG. 4 the non-secure IP blocks IP_A, IP_B are grouped together and labelled using reference numeral 400 and the secure IP blocks IP_C, IP_D, IP_E, IP_F are grouped together and labelled using reference numeral 402.

A further example operation of a practical implementation of the secure electronic apparatus 106 of FIG. 2 may be summarised as follows.

A sequence of steps may be undertaken to enforce a low-overhead security management system upon boot of the SoC as follows:
1. At boot time of the electronic device 100, the security processor core 204 boots first (prior to APU 208) and executes the initialization defined in the security firmware 210.
2. The initialization sequence enables the security management system 102 to enforce a virtual secure enclave on specific IP (the IP blocks 402) and prevents other workloads from being scheduled on the secure enclave.
3. The security management system 102 also claims specific memory blocks (the memory blocks 202) in the memory sub-system 110 as components of secure enclave, dealing with storage of model weights and activations. Memory access definitions are also part of the compiled binary of the model (the compiled AI model 212).
4. Secure firmware 210 will request OTP as stored in the OTP register 206 to decrypt the secure AI model through the security management system 102, to ensure model weights are available to secure IP 402 and secure memory 202.
5. At application runtime, the non-secured APU 208 can only leverage the secure enclave as a black box for performing inference, with the security management system 102 acting as the secure scheduler for the secure enclave.
6. Streaming data is transmitted to the black box to be processed during inference and final results are written into APU memory area, for example the non-secure memory blocks 200. The approach prevents the APU 208 from accessing the AI model characteristics or artifacts, thereby securing the AI model from unauthorized read/write/modify/erase operations.

It should be noted that the term “black box” is used here in its normal meaning in the technical field as will be clear to the skilled person. Specifically, the black box may receive an input, perform a function, and then provide an output, with a user having no access to the inner workings of the black box in how it provides its function.

A further example operation of a practical implementation of the secure electronic apparatus 106 of FIG. 2 may be summarised as follows.

When an AI model update is received, it is possible that the secure enclave definition changes. The OTP will remain the same within the OTP register 206. A sequence of steps may be undertaken to update the reconfigurable secure enclave definition by redefining the scope of a root-of-trust within the SoC after the secure AI model update, which may be summarised as follows:
1. The AI model owner flashes the encrypted compiled AI model 212 to the set of memory storage blocks 202, which may involve known techniques of decryption and signature verification.
2. The SoC is then power reset and, at boot time, the security management system 102 is reinitialized with the updated definition of the secure enclave.
3. The secure processor core 204 carries out checks to validate the changes in secure enclave by requesting non-secure IP to trigger the secure IP and secure memory blocks.

Root-of-trust (RoT) is a well-known term in the technical field. A RoT is a component of a system that is considered as trusted and can be used as the foundation for defining or developing the security of an overall system.

Embodiments of the present disclosure may provide model owner defined security firmware capable of boot-time reconfiguration of root-of-trust. This can enable secure model storage through over-the-air (OTA) updates and secure model access to specific hardware acceleration IP within the SoC. Additionally, this can prevent unauthorized model access to model artifacts.

In specific embodiments of the present disclosure, each stakeholder may be given the same compiled AI model with a unique defined secure enclave based on the security management configuration file 116 defined by the AI model owner. This enables an AI product to be co-developed and overcomes the shortcomings of known systems relating to universal static security measures and high-overhead safety-domains.

Various improvements and modifications may be made to the above without departing from the scope of the disclosure.

1. An electronic device comprising a security management system configured to control access to each of a plurality of system components based on a reconfigurable secure enclave definition.

2. The electronic device of claim 1, further comprising a plurality of artificial intelligence (AI) hardware acceleration intellectual property (IP) blocks.

3. The electronic device of claim 2, wherein the security management system is configured to control access to:
each of the plurality of AI hardware acceleration IP blocks based on the reconfigurable secure enclave definition; and/or
each of a plurality of memory storage blocks based on the reconfigurable secure enclave definition.

4. The electronic device of claim 3, further comprising a memory interface configured to permit communication between the electronic device and a memory sub-system comprising the plurality of memory storage blocks.

5. The electronic device of claim 3, wherein one or more of the plurality of memory storage blocks is configured to store a compiled artificial intelligence (AI) model comprising the reconfigurable secure enclave definition.

6. The electronic device of claim 5, wherein the compiled AI model is received by the one or more of the plurality of memory storage blocks from a compiler configured to:
receive a first pre-trained AI model;
receive a first security management configuration file that describes a first setting for the reconfigurable secure enclave definition; and
generate the compiled AI model comprising the first pre-trained AI model and the reconfigurable secure enclave definition based on the first setting.

7. The electronic device of claim 5, further comprising a security processor core comprising the security management system and configured to decrypt the compiled AI model using a one-time password.

8. The electronic device of claim 7, further comprising an application processor unit (APU).

9. The electronic device of claim 8, wherein the security management system is configured to restrict the APU's access to one or more of the plurality of system components based on the reconfigurable secure enclave definition.

10. The electronic device of claim 9, wherein the security processor core is configured to perform an initialization sequence based on security firmware, the initialization sequence being used to enforce the reconfigurable secure enclave definition prior to activation of the APU.

11. The electronic device of claim 6, wherein
the one or more of the plurality of memory storage blocks is configured to store an updated compiled artificial intelligence (AI) model comprising the reconfigurable secure enclave definition; and
the updated compiled AI model is received by the one or more of the plurality of memory storage blocks from the compiler configured to:
receive a second pre-trained AI model;
receive a second security management configuration file that describes a second setting for the reconfigurable secure enclave definition; and
generate an updated compiled AI model comprising the second pre-trained AI model and the reconfigurable secure enclave definition based on the second setting.

12. The electronic device of claim 11, wherein the security processor core is configured to:
perform an initialization sequence based on security firmware, the initialization sequence being used to enforce the reconfigurable secure enclave definition based on the first setting, after the one or more of the plurality of memory storage blocks receives the compiled AI model; and
perform a re-initialization sequence based on security firmware, the re-initialization sequence being used to enforce the reconfigurable secure enclave definition based on the second setting, after the one or more of the plurality of memory storage blocks receives the updated compiled AI model.

13. The electronic device of claim 12, wherein the device is configured to undergo a power reset procedure after the one or more of the plurality of memory storage blocks receives the updated compiled AI model and before the security processor core performs the re-initialization sequence.

14. The electronic device of claim 12, wherein the secure processor core is configured to validate the changes to the reconfigurable secure enclave definition after re-initialization.

15. The electronic device of claim 1, wherein the electronic device is a system-on-chip (SoC), a microcontroller unit (MCU), chiplets or a system-on-module.

16. A secure electronic apparatus comprising:
a plurality of memory storage blocks;
an electronic device comprising:
a plurality of artificial intelligence (AI) hardware acceleration intellectual property (IP) blocks; and
a security management system configured to control access to:
each of the plurality of AI hardware acceleration IP blocks based on a reconfigurable secure enclave definition; and/or
each of the plurality of memory storage blocks based on the reconfigurable secure enclave definition; and
a compiler configured to:
receive a first pre-trained AI model;
receive a first security management configuration file that describes a first setting for the reconfigurable secure enclave definition; and
generate the compiled AI model comprising the first pre-trained AI model and the reconfigurable secure enclave definition based on the first setting;
wherein one or more of the plurality of memory storage blocks is configured to:
receive the compiled AI model from the compiler; and
store the compiled artificial intelligence (AI) model comprising the reconfigurable secure enclave definition.

17. A method of controlling access to each of a plurality of system components based on a reconfigurable secure enclave definition using a security management system of an electronic device.

18. The method of claim 17, wherein the electronic device comprises a plurality of artificial intelligence (AI) hardware acceleration intellectual property (IP) blocks, the method comprising:
controlling access, using the security management system, to:
each of the plurality of AI hardware acceleration IP blocks based on the reconfigurable secure enclave definition; and/or
each of a plurality of memory storage blocks based on the reconfigurable secure enclave definition.

19. The method of claim 18, further comprising storing a compiled artificial intelligence (AI) model comprising the reconfigurable secure enclave definition using one or more of the plurality of memory storage blocks.

20. The method of claim 19, further comprising:
receiving a first pre-trained AI model at a compiler;
receiving a first security management configuration file that describes a first setting for the reconfigurable secure enclave definition at the compiler;
generating, using the compiler, the compiled AI model comprising the first pre-trained AI model and the reconfigurable secure enclave definition based on the first setting; and
receiving, using the one or more of the plurality of memory storage blocks, the compiled AI model from the compiler.

21. The method of claim 20, further comprising:
storing an updated compiled artificial intelligence (AI) model comprising the reconfigurable secure enclave definition using the one or more of the plurality of memory storage blocks;
receiving a second pre-trained AI model at a compiler;
receiving a second security management configuration file that describes a second setting for the reconfigurable secure enclave definition at the compiler;
generating, using the compiler, the updated compiled AI model comprising the second pre-trained AI model and the reconfigurable secure enclave definition based on the second setting; and
receiving, using the one or more of the plurality of memory storage blocks, the updated compiled AI model from the compiler.
